(19) United States
(12) Patent Application Publication
(10) Pub. No.: US 2004/0086701 A1
(43) Pub. Date: May 6, 2004

(54) Reinforced structural element

(76) Inventors: Harald Brinkschroeder, Boeblingen (DE); Wolfgang Fussnegger, Tuebingen (DE); Karl-Heinz Fueller, Neu-Ulm (DE); Tilman Haug, Weissenborn (DE); Michael Scheydecker, Nersingen (DE); Tanja Tschirge, Donzdorf (DE); Karl-Ludwig Weisskopf, Rudersberg (DE)

Correspondence Address: Crowell & Moring, PO Box 14300, Washington, DC, 20044-4300, US

(21) Appl. No.: 10/466,425

(22) PCT Filed: Dec. 12, 2001
(86) PCT No.: PCT/EP01/14621

(30) Foreign Application Priority Data
Jan. 16, 2001 (DE) 101 01 650.6

(51) Int. Cl. B22D 19/14; B32B 15/04

(52) U.S. Cl. 428/293.1; 164/98

(57) ABSTRACT

The invention relates to a reinforced structural element comprising a metallic matrix and a reinforcement comprising inorganic fibers, the reinforcement at least partially penetrating through the structural element. The reinforcement is designed in the form of a fabric in at least two dimensions. The structural element with a wall thickness of between 0.2 mm and 5 mm takes the form of a metal sheet or semifinished product.

The invention relates to a reinforced structural element as claimed in patent claim 1 and to a process for producing a structural element of this type as claimed in patent claim 7.

Reinforcements to plastics by means of fabrics or fibers are generally known. The range of such reinforcements extends from reinforced films which are reinforced with two-dimensional fabric through laminated plastic bodywork parts which are preferably used in racing or the aeronautical sector. In this case, a plurality of layers of fabrics, which generally comprise organic fibers, are placed on top of one another and impregnated with a synthetic resin. Although processes of this type produce lightweight structural components, their use in automobile mass production is not economically viable for cost reasons.

Further types of reinforcements are employed in the field of internal combustion engines, for example for connecting rods, pistons or cylinder liners. An example which can be mentioned in this context is U.S. Pat. No. 4,266,596. This document describes the production of a composite material by the unidirectional bundling of fibers. The result is an increase in the strength in particular of highly loaded engine components, but these fiber reinforcements are unsuitable for large-area thin-walled components for example in bodywork, since considerable embrittlement of the material goes hand in hand with the higher strength.

Therefore, the object consists in producing a structural element which can be produced at lower cost compared to the prior art and has a higher elongation at break.

The object is achieved by a structural element as claimed in patent claim 1 and by a process as claimed in patent claim 8.

The structural element according to the invention is generally designed as a thin-walled metal sheet or semifinished product and is reinforced by a fabric. The fabric at least partially penetrates through the structural element and is arranged in two-dimensional or three-dimensional form. The fabric comprises inorganic fibers or wires which can be successfully integrated in a metallic matrix in particular by casting of the metal.

In the text which follows, the term fabric is to be understood as meaning all structures in which fibers (short fibers or endless fibers) and/or wires (=metallic fibers) are combined with one another. These include in particular woven, knitted or braided structures as well as nonwovens, felts or other random structures. In this context, a two-dimensional structure is understood as meaning, for example, a woven structure in which the fibers extend substantially in two spatial directions (the x and y directions). This is also true of woven structures which are in the form of a plurality of layers on top of one another. By contrast, a three-dimensional structure is, for example, a knitted structure or a needled nonwoven, in which the fibers run both in the x and y directions and also in a z direction.

In principle, all inorganic materials are suitable for the fibers or wires. However, metallic wires (in particular based on iron) or ceramic fibers (including carbon fibers), which have sufficient oxidation resistance with respect to a liquid metal, are particularly suitable. Fabrics may also comprise various types of fibers and/or wires. In the text which follows, fibers and wires are referred to as just fibers for the sake of simplicity.

Metal sheets which have a reinforcement in accordance with the invention have significantly higher elongations at break than conventional metal sheets. The reinforcing fabric is deformed elastically and prevents the propagation of cracks in the metallic matrix. In this way, it is possible for the structural element to absorb a higher degree of impact energy than is the case with conventional structural elements.

The energy absorption by the reinforced structural element is further optimized if the reinforcement is macroscopic in form. In this context, the term macroscopic means that the fiber thickness and the mesh width of the fabric are of approximately the same order of magnitude as the wall thickness of the structural element, in which case the fabric may include different fiber thicknesses. In the case of standard components, this means that the fiber thickness is between 1 μm and 10 mm; in practice, from 0.2 mm to 1 mm is preferred (claim 2). This is also true of the mesh width of the fabric, which is between 2 μm and 20 mm, in practice between 0.4 mm and 2 mm (claim 3).

The matrix and the fabric advantageously do not merge monolithically into one another, but rather either have an interlayer or a microscopically interrupted bonding. This leads to what is known as a pull-out effect. This effects energy absorption by microscopic movement of the fibers in the matrix. This effect is achieved by the fibers being either coated or roughened. In this context, it is advantageous if the modulus of elasticity (E modulus) of the fiber is greater than the modulus of elasticity of the matrix (claim 4).

In addition to the abovementioned good chemical compatibility with respect to the metallic matrix and the high elongation at break, metallic fibers also have good mechanical deformability, so that the fabric can be produced already virtually in the shape of the structural element (claim 5).

The matrix preferably consists of the light metals aluminum or magnesium, or alternatively it is also possible to use steel. These metals, in particular their alloys, are standard structural metals and have good casting properties. Moreover, the above-mentioned materials are available at low cost and can be economically employed in relatively large quantities (claim 6).

The structural element according to the invention is preferably used in vehicle bodies. Examples of suitable components which can be mentioned in this context are integral beams, longitudinal beams, inner parts of doors or pillars. These components are responsible for absorbing crash energy in particular in crash situations. The inventive reinforcement of these structural elements can further improve conventional crash structures or replace more expensive structures (claim 7).

A further configuration of the invention is a process for producing a structural component as claimed in patent claim 8.

The process is distinguished by the fact that a fabric is brought into the shape of the structural element which is to be produced, in particular by a forming process, e.g. by pressing or bending. Certain knitting processes also make it possible to directly reproduce complex shapes, so that it is possible to substantially dispense with a mechanical forming process.

Following the shaping of the fabric, the latter is placed into a casting mold and held in place. This can be achieved, for example, magnetically or by means of a positively locking fit. As the process continues, the casting mold is filled with liquid metal, with the result that the structural element is formed. After the metal has solidified, the structural element is demolded from the casting mold. As a result, the fabric is completely surrounded by the matrix metal. The process according to the invention therefore provides a very inexpensive method of producing complex structural elements having the reinforcement in accordance with the invention.

To achieve the abovementioned pull-out effect, it is expedient for the fibers of the fabric to be coated or roughened before the fabric is produced or before the shaping process or before the fabric is placed into the casting mold. Suitable coating processes are dip coating, physical or chemical vapor deposition processes, such as for example phosphating. Suitable roughening surface treatments include tribochemical treatments, treatments with acid or lye, sandblasting or treatment by electrochemical reactions (claim 9).

Particularly suitable casting processes for production of the structural element according to the invention are pressure die casting processes. These include both conventional pressure die casting, squeeze casting and low-pressure die casting processes. Applying pressure to the casting metal leads to a more homogeneous distribution of the matrix metal around the reinforcing fabric. Voids and bubbles can be minimized with optimum bonding between fabric and matrix. In the abovementioned processes, it is customary to use a pressure of between 10 bar (low-pressure die casting) and 1000 bar (pressure die casting). In addition to the pressure die casting processes, in particular when casting steel, gravity die casting is also suitable for production of the structural element according to the invention (claim 10).

The text which follows explains the invention in more detail with reference to an exemplary embodiment.

The only FIGURE diagrammatically depicts the process for producing the structural element in accordance with the invention.

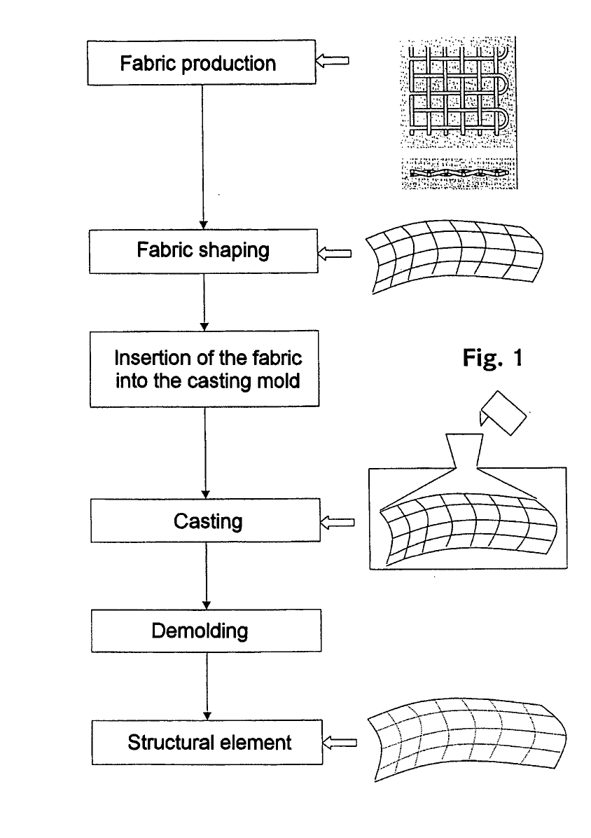

The left-hand half of FIG. 1 shows the individual, successive process steps, a coating or roughening of the fibers, which usually takes place before production of the fabric, not being included in the illustration. The right-hand half diagrammatically depicts the state of a structural element in the individual process steps.

The fabric illustrated is in this case of two-dimensional configuration in a simple woven form. In principle, all combinations of fibers which can be produced mechanically are conceivable. In the second process step, the fabric is deformed in such a way that it approximately corresponds to the form of the structural element (fabric forming). For this purpose, the fabric is placed into a press tool which reproduces the desired outer contours. In principle, it is possible to carry out this process step directly in the casting mold by placing the unshaped fabric into the casting mold and closing the latter.

In the next process step, the shaped fabric is placed into the casting mold, held in place there (insertion of the fabric into the casting mold), and the casting mold is filled with liquid metal (casting). FIG. 1 diagrammatically depicts the casting by gravity die casting, which is expedient in particular when casting steel. Light metals, such as aluminum and magnesium, are preferably cast under pressure. A pressure die casting machine or a squeeze casting machine is customarily used for this purpose.

This is followed by the demolding of the finished structural element, which if necessary is remachined slightly (e.g. deburring).

1. A reinforced structural element comprising a metallic matrix and a reinforcement comprising inorganic fibers, the reinforcement at least partially penetrating through the structural element, characterized in that
the reinforcement is configured in the form of a fabric in at least two dimensions,
the structural element is designed in the form of a metal sheet or semifinished product, the wall thickness of which is between 0.2 mm and 5 mm.

2. The reinforced structural element as claimed in claim 1, characterized in that the diameter of the fibers is between 0.1 μm and 10 mm.

3. The reinforced structural element as claimed in claim 1 or 2, characterized in that a mesh width of the fabric is between 0.25 μm and 25 mm.

4. The reinforced structural element as claimed in one of the preceding claims, characterized in that the bonding between fibers and matrix is microscopically interrupted, or in that fibers and matrix are separated by an intermediate layer.

5. The reinforced structural element as claimed in one of the preceding claims, characterized in that the fibers of the fabric comprise metallic wires.

6. The reinforced structural element as claimed in one of the preceding claims, characterized in that the matrix consists of aluminum, magnesium, iron or an alloy of these elements.

7. The reinforced structural element as claimed in one of the preceding claims, characterized in that the structural element is designed as part of a body of a vehicle.

8. A process for producing the reinforced structural element as claimed in one of claims 1 to 7, characterized in that
a fabric is brought into the shape of the structural element,
the shaped fabric is placed into a casting mold,
the casting die is filled with liquid metal, and
after the metal has solidified, the structural element is demolded from the casting mold.

9. The process as claimed in claim 8, characterized in that the fibers are coated or roughened before being placed into the casting mold.

10. The process as claimed in claim 8 or 9, characterized in that the liquid metal is introduced into the casting mold under pressure.
